(19) United States
(12) Patent Application Publication
(10) Pub. No.: US 2024/0045372 A1
(43) Pub. Date: Feb. 8, 2024

(54) IMAGING SYSTEM WITH AIR PASSAGE FOR DEVELOPMENT CHAMBER

(71) Applicant: HEWLETT-PACKARD DEVELOPMENT COMPANY, L.P., Spring, TX (US)

(72) Inventors: Tadao MORI, Yokohama, Kanagawa (JP); Naoya IWATA, Yokohama, Kanagawa (JP); Satoshi MURAMATSU, Yokohama, Kanagawa (JP)

(21) Appl. No.: 17/641,979

(22) PCT Filed: Aug. 27, 2020
(86) PCT No.: PCT/US2020/048185

§ 371 Date: Mar. 10, 2022

(30) Foreign Application Priority Data
Sep. 24, 2019 (JP) 2019-173387

(51) Int. Cl. G03G 21/20; G03G 15/08

(52) U.S. Cl. CPC G03G 21/206; G03G 15/0812

(57) ABSTRACT

An imaging system includes a housing, a developer roller that transfers developer to an image carrier at a development region, a developer regulator to limit a thickness of the developer carried on the developer roller, and an air passage that extends outside a development chamber. The air passage has an inlet to draw an airflow, and an outlet located between the developer regulator and the development region. The air passage has a cross section orthogonal to a direction of the airflow from the inlet to the outlet. In the cross section taken at the narrowest position where the air passage is the narrowest, a width in a width direction parallel to a rotational axis of the developer roller is greater than a thickness that is perpendicular to the width direction.

### BACKGROUND

Some imaging apparatuses have a developing device that is equipped with a developing roller and a flow passage member that extends longitudinally in a rotational direction of the developer roller, between the developer roller and an inner wall of a main body of the developing device so as to release pressure inside the developing device main body and to inhibit a toner from scattering outside the developing device main body.

### BRIEF DESCRIPTION OF DRAWINGS

FIG. 1 is a schematic diagram of an example imaging apparatus.

FIG. 2 is a schematic cross-sectional view of an example developing device adjacent an image carrier.

FIG. 3 is a schematic longitudinal cross-sectional view of the example developing device.

FIG. 4 is a schematic cross-sectional view of the example developing device.

FIG. 5 is a schematic diagram illustrating a planar development of a longitudinal cross-section of an example air passage in an example developing device.

FIG. 6 is a schematic transverse cross-sectional view of the air passage illustrated in FIG. 5, taken along line VI-VI.

FIG. 7 is a partial view of the schematic diagram of FIG. 5, illustrating an inlet of the example air passage.

FIG. 8 is a partial view of the schematic diagram of FIG. 5, illustrating an outlet of the example air passage.

FIG. 9 is a schematic diagram representing a planar development of a cross-section of a portion of an example air passage illustrating an outlet of the example air passage.

FIG. 10 is a schematic cross-sectional view of an example developing device including another example air passage.

FIG. 11 is a schematic cross-sectional view illustrating a part of an example air passage including example air guide portions.

FIG. 12 is a schematic cross-sectional view illustrating a part of an example air passage including an example guide portion.

FIG. 13 is a schematic cross-sectional view of another example developing device.

FIG. 14 is a schematic cross-sectional view illustrating a stir portion of an example developing device, including an example check valve.

FIG. 15 is a schematic cross-sectional view illustrating another example developing device.

FIG. 16 is a schematic diagram illustrating a planar development of a longitudinal cross-section of an example air passage.

FIG. 17 is a schematic cross-sectional view illustrating an example developing device.

FIG. 18 is a schematic diagram illustrating a planar development of a longitudinal cross-section of an example air passage.

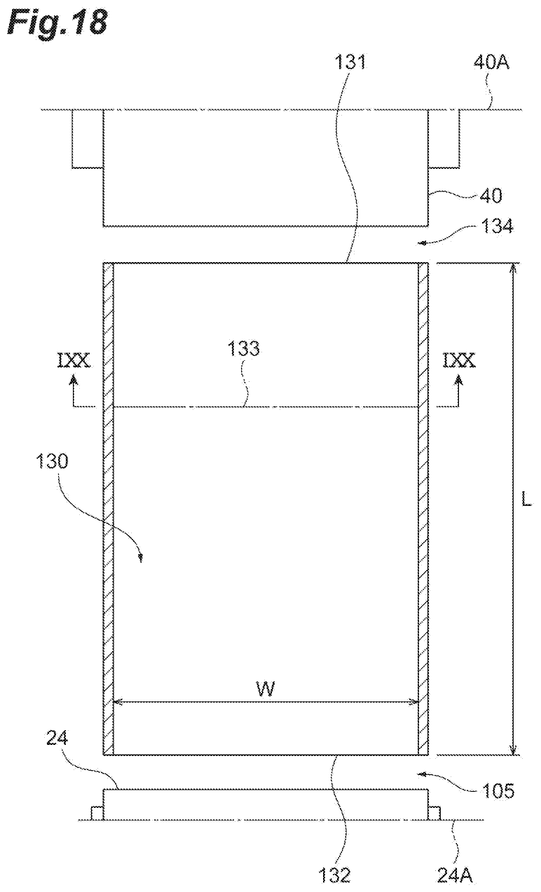

FIG. 19 is a schematic transverse cross-sectional view of the air passage illustrated in FIG. 18, taken along line IXX-IXX.

FIG. 20 is a schematic cross-sectional view illustrating a part of an example developing device including an example pressure increase inhibition portion.

FIG. 21 is a schematic cross-sectional view illustrating part of an example developing device including an example pressure increase inhibition portion.

FIG. 22 is a schematic cross-sectional view of an example developing device.

FIG. 23 is a schematic cross-sectional view of an example developing device.

FIG. 24 is a schematic diagram illustrating a planar development of a longitudinal cross-section of an example air passage.

FIG. 25 is a schematic cross-sectional view illustrating an example developing device.

### DETAILED DESCRIPTION

Hereinafter, an example imaging system will be described with reference to the drawings. The imaging system may be an imaging apparatus such as printer, or may be a developing device to be used in an imaging apparatus or the like. In the following description, with reference to the drawings, the same reference numbers are assigned to the same components or to similar components having the same function, and overlapping description is omitted.

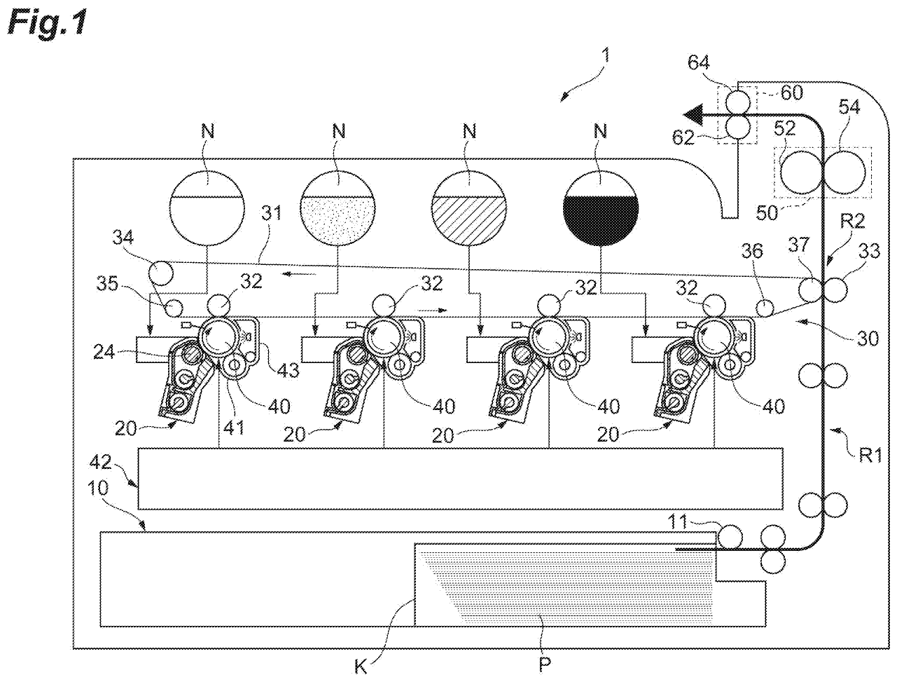

With reference to FIG. 1, an example imaging apparatus 1 may form a color image using four colors such as magenta, yellow, cyan, and black. The example imaging apparatus 1 includes a transport device 10, a developing device 20, a transfer device 30, an image carrier 40, a fixing device 50 and an output device 60. The transport device 10 transports a paper P which is a recording medium. The image carrier 40 has a surface (peripheral surface) on which an electrostatic latent image is formed. The developing device 20 develops the electrostatic latent image to generate a toner image. The transfer device 30 secondarily transfers the toner image onto the paper P. The fixing device 50 fixes the toner image onto the paper P. The output device 60 outputs the paper P.

The transport device 10 transports or conveys the paper P, which is a recording medium on which an image is to be formed, along a transport path R1. The papers (or sheets of paper) P are stacked and accommodated in a cassette K, and are picked up and transported by a paper feeding roller 11. The transport device 10 causes the paper P to reach a transfer nip region R2 via the transport path R1 at the timing the toner image to be transferred onto the paper P reaches the transfer nip region R2.

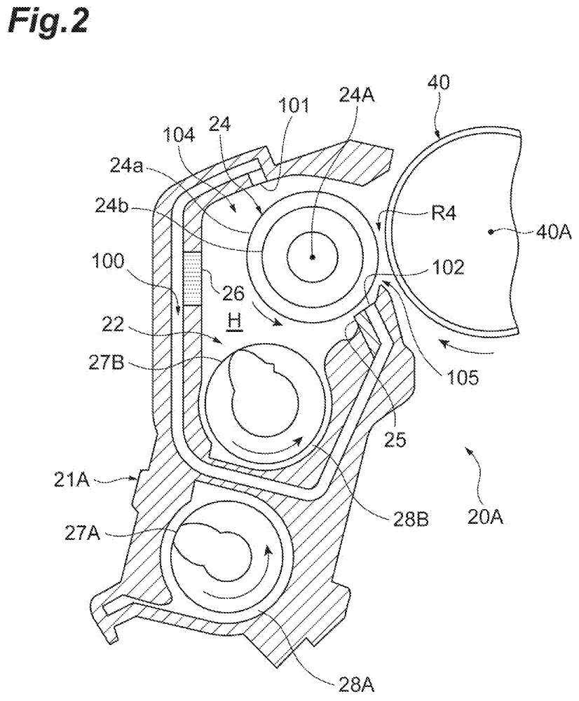

Four developing devices 20 are provided, one for each of the colors. Each of the developing devices 20 includes a developer roller 24 that carries a toner to the image carrier 40. As a developer, the developing device 20 uses a two-component developer containing a toner (e.g., toner particles) and a carrier (e.g., carrier particles). In some examples, in the developing device 20, the developer is adjusted to have an optimal charge amount by adjusting amounts of the toner and the carrier to form a targeted mixing ratio, and by further mixing and stirring the toner and the carrier to uniformly disperse the toner in the developer. The developer is carried on the developer roller 24 which rotates. When the developer is transported to a development region R4 (refer to FIG. 2), which faces the image carrier 40, via the rotation of the developer roller 24, the toner in the developer that is carried on the developer roller 24 moves onto the electrostatic latent image formed on the peripheral surface of the image carrier 40, so that the electrostatic latent image is developed.

The transfer device 30 transports the toner image, which has been formed by the developing device 20, to the transfer nip region R2 where the toner image is to be secondarily transferred onto the paper P. The transfer device 30 includes a transfer belt 31, suspension rollers 34, 35, 36, and 37, primary transfer rollers 32, and a secondary transfer roller 33. The toner image is primarily transferred from the image carrier 40 onto the transfer belt 31 which is suspended (or supported) on the suspension rollers 34, 35, 36, and 37. The transfer belt is pinched (or sandwiched) between the primary transfer rollers 32 and the respective image carriers 40 of the developing devices 20. The transfer belt 31 is further pinched between the secondary transfer roller 33 and the suspension roller 37.

The transfer belt 31 is an endless belt which is circulated by the suspension rollers 34, 35, 36, and 37. The suspension rollers 34, 35, 36, and 37 are rotatable about respective rotational axes. The suspension roller 37 may be a drive roller that rotates about its rotational axis, and the suspension rollers 34, 35, and 36 may be driven rollers that are driven to rotate by the rotation of the suspension roller 37. The primary transfer roller 32 is pressed against the image carrier 40 from an inner peripheral side of the transfer belt 31. The secondary transfer roller 33 extends parallel to the suspension roller 37 with the transfer belt 31 interposed therebetween, so as to press against the suspension roller 37 from an outer peripheral side of the transfer belt 31.

Accordingly, the transfer nip region R2 is formed between the secondary transfer roller 33 and the transfer belt 31.

The image carrier 40 is also called an electrostatic latent image carrier, a photoconductor drum, or the like. Four image carriers 40 are provided, one for each of the colors. The image carriers 40 are provided along a movement direction of the transfer belt 31. The developing device 20, a charging roller 41, an exposure unit 42, and a cleaning unit 43 are provided adjacent (e.g., around) each image carrier 40.

The charging roller 41 may charge the surface of the image carrier 40 with a predetermined potential. The charging roller 41 moves (rotates) following the rotation of the image carrier 40. The exposure unit 42 exposes the surface of the image carrier 40, which has been charged by the charging roller 41, to a light according to the image to be formed on the paper P. Accordingly, the potential of a portion of the surface of the image carrier 40, which has been exposed to light by the exposure unit 42, is changed so that the electrostatic latent image is formed. The four developing devices 20 develop the electrostatic latent images, which are formed on the respective image carriers 40, with the respective toners supplied from toner tanks N that faces the developing devices 20, respectively, so that the toner images is generated. The toner tanks N are respectively filled with magenta, yellow, cyan, and black toners and carrier of the amount corresponding to toner filling amounts. The cleaning unit 43 recovers the toner which remains on the image carrier 40 after the toner image formed on the image carrier 40 is primarily transferred onto the transfer belt 31.

After the toner image has been secondarily transferred onto the paper P from the transfer belt 31, the paper P passes through fixing device 50, having a fixing nip region where heat and pressure are applied to the paper P. The fixing device 50 attaches and fixes the toner image onto the paper P. The fixing device 50 includes a heating roller 52 that heats the paper P, and a pressure roller 54 that presses against and rotates the heating roller 52. The heating roller 52 and the pressure roller 54 are formed into a cylindrical shape. The heating roller 52 includes a heat source such as a halogen lamp thereinside. The fixing nip region which is a contact area is provided between the heating roller 52 and the pressure roller 54. When the paper P passes through the fixing nip region, the toner image is melted and fixed onto the paper P.

The output device 60 includes output rollers 62 and 64 for outputting the paper P, onto which the toner image has been fixed by the fixing device 50, outside the apparatus.

An example printing process performed by the example imaging apparatus 1 will be described. When an image signal for a recorded image is input into the imaging apparatus 1, a control unit of the imaging apparatus 1 rotates the paper feeding roller 11, so that the papers P stacked in the cassette K are picked up and transported. Then, the surface of the image carrier 40 is uniformly charged with the predetermined potential by the charging roller 41 (charging operation). Thereafter, based on the received image signal, the exposure unit 42 irradiates the surface of the image carrier 40 with laser beams, so that an electrostatic latent image is formed (exposure operation).

In the developing device 20, the electrostatic latent image is developed to form a toner image (development operation). The toner image formed described above is primarily transferred onto the transfer belt 31 from the image carrier 40 at a region where the image carrier 40 faces the transfer belt 31 (transfer operation). The toner images formed on four image carriers 40 are sequentially layered on the transfer belt 31 to form a single composite toner image. Then, the composite toner image is secondarily transferred onto the paper P, which has been transported from the transport device 10, at the transfer nip region R2 where the suspension roller 37 faces the secondary transfer roller 33.

The paper P, onto which the composite toner image has been secondarily transferred, is transported to the fixing device 50. Then, when the paper P passes through the fixing nip region, the fixing device 50 melts and fixes the composite toner image onto the paper P by heating and pressing the paper P between the heating roller 52 and the pressure roller 54 (fixation operation). Thereafter, the paper P is output outside the imaging apparatus 1 by the output rollers 62 and 64.

FIG. 2 is a schematic cross-sectional view of an example developing device 20A that may be installed into the example imaging apparatus 1 illustrated in FIG. 1. The example developing device 20A illustrated in FIG. 2 includes an image carrier 40 that is rotatable, a housing 21A, a stir portion (or stirring portion) 22, a developer roller 24 that is rotatable, a developer regulator 25, and an air passage (or air flow passage) 100.

An electrostatic latent image may be formed on the surface of the image carrier 40, as previously described. The image carrier 40 is rotatably supported on the housing 21A, and is rotated by a drive source such as a motor. The image carrier 40 may have a columnar shape.

The housing 21A is a container that houses the developing device 20A, and has a development chamber H therein. The development chamber H of the housing 21A accommodates developer containing a toner and a carrier. In addition, the development chamber H of the housing 21A accommodates the stir portion 22, the developer roller 24, and the developer regulator 25. The housing 21A has an opening at a position where the developer roller 24 faces the image carrier 40. The toner in the development chamber H is supplied from the opening to the image carrier 40. The housing 21A includes a filter 26 that allows air to pass therethrough, into and from the development chamber H, while preventing the developer from passing therethrough. The housing includes a developer output port through which aged developer is discharged from the development chamber H.

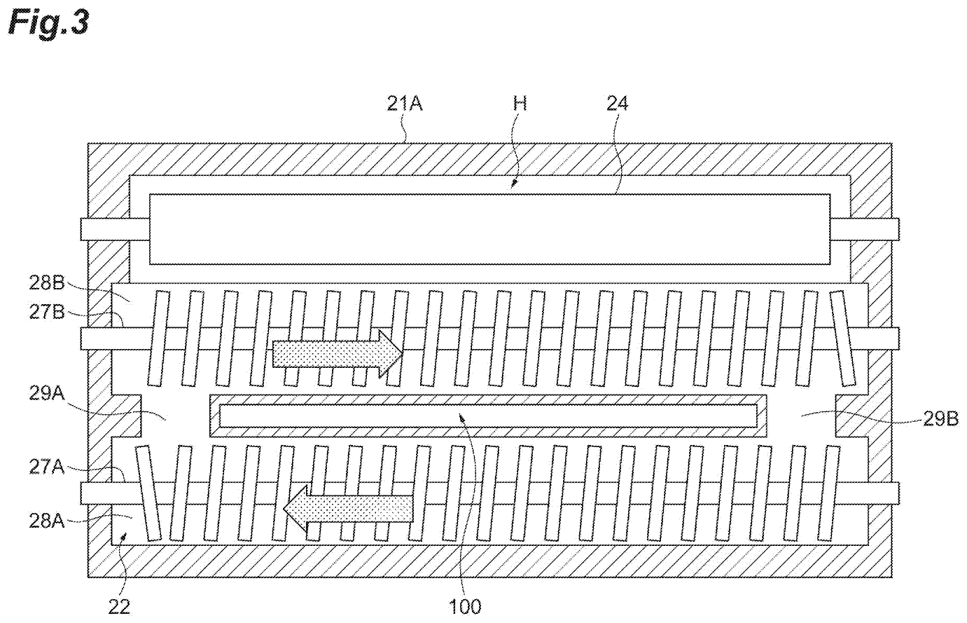

With reference to FIGS. 2 and 3, the stir portion 22 stirs and supplies the developer to the developer roller 24. The stir portion 22 includes a first stir and transport member 27A and a second stir and transport member 27B. The first stir and transport member 27A and the second stir and transport member 27B stir the carrier and the toner in the development chamber H, in order to charge, by friction, the carrier and the toner which form the developer. The carrier is a magnetic material and the toner is a non-magnetic material. In addition, the first stir and transport member 27A and the second stir and transport member 27B transport (or convey) the developer while stirring the developer in the development chamber H. The first stir and transport member 27A is located in a first stir and transport path 28A positioned at a bottom portion of the development chamber H. The second stir and transport member 27B is located in a second stir and transport path 28B positioned at an upper portion of the first stir and transport path 28A, and faces the developer roller 24. Accordingly, the second stir and transport path 28B is located between the first stir and transport path 28A and the developer roller 24. The first stir and transport path 28A and the second stir and transport path 28B extend in a direction parallel to a rotational axis 24A of the developer roller 24. The first stir and transport path 28A and the second stir and transport path 28B are located adjacent to each other. A first supply port 29A for supplying the developer from the first stir and transport path 28A to the second stir and transport path 28B is formed at a first end portion (e.g., in an end portion on one side) of the first stir and transport path 28A and the second stir and transport path 28B. A second supply port 29B for supplying the developer from the second stir and transport path 28B to the first stir and transport path 28A is formed at a second end portion (e.g., in an end portion on the other side) of the first stir and transport path 28A and the second stir and transport path 28B. Namely, the first stir and transport path 28A and the second stir and transport path 28B are partitioned off from each other with a wall which is part of the housing 21A. The first supply port 29A and the second supply port 29B are formed in the wall. Then, while stirring the developer, the first stir and transport member 27A transports the developer on the first stir and transport path 28A in a first direction to supply the developer from the first supply port 29A to the second stir and transport path 28B. While stirring the developer on the second stir and transport path 28B, the second stir and transport member 27B transports the developer in a second direction which is opposite to the first direction, to supply the developer from the second supply port 29B to the first stir and transport path 28A. Then, the developer which is transported on the second stir and transport path 28B by the second stir and transport member 27B is supplied to the developer roller 24.

As illustrated in FIG. 2, the developer roller 24 is positioned to face the image carrier 40 and so as to form a gap between the image carrier 40 and the developer roller 24. The developer roller 24 rotates and has a surface that carries the developer, which is accommodated in the housing 21A. The developer roller 24 is formed into, for example, a columnar shape. The developer roller 24 is located such that the rotational axis 24A of the developer roller 24 is parallel to a rotational axis 40A of the image carrier 40 and the gap between the developer roller 24 and the image carrier 40 is substantially uniform (or constant) in a longitudinal direction which is substantially parallel to the direction of the rotational axis 24A and the direction of the rotational axis 40A. The developer stirred by the first stir and transport member 27A and the second stir and transport member 27B are carried on the surface of the developer roller 24. When the developer roller 24 transports the carried developer to the development region R4, the electrostatic latent image on the image carrier 40 is developed. The development region R4 is located between the developer roller 24 and the image carrier 40, where the developer roller 24 faces the image carrier 40. The development region R4 may be a region where the developer roller 24 is the closest to the image carrier 40.

The developer roller 24 includes a developer sleeve 24a forming a surface layer of the developer roller 24, and a magnet 24b located inside the developer sleeve 24a. The developer sleeve 24a is a cylindrical member made of non-magnetic metal. The developer sleeve 24a is rotatable about the rotational axis 24A. The magnet 24b is, for example, fixed to a shaft on the rotational axis 24A which is fixed to the housing 21A, and has a plurality of magnetic poles. In some examples, the developer sleeve 24a is rotatably supported on the shaft, to be rotated by a drive source such as a motor. The developer is carried on the surface of the developer sleeve 24a due to a magnetic force of the magnet 24b. As the developer sleeve 24a rotates, the developer roller 24 transports the developer in a rotational direction of the developer sleeve 24a.

The developer forms bristles on the developer sleeve 24a as a result of the magnetic force of the magnetic poles of the magnet 24b. The bristles of the developer may also be referred to as magnetic brushes or developer bristles. The developer roller 24 brings the developer bristles, which are formed by the magnetic poles, into contact with or adjacent to the electrostatic latent image on the image carrier 40 in the development region R4. Accordingly, the toner in the developer carried on the developer roller 24 transfers onto the electrostatic latent image formed on the peripheral surface of the image carrier 40, so that the electrostatic latent image is developed.

The developer regulator 25 limits the thickness of the developer carried on the developer roller 24. For example, the developer regulator 25 limits the carrying amount of the developer carried on the developer roller 24. The developer regulator 25 is located adjacent to the development region R4 on an upstream side of the development region R4 in the rotational direction of the developer sleeve 24a. A predetermined gap is formed between the developer regulator 25 and the developer sleeve 24a. Consequently, when the developer sleeve 24a rotates, the developer regulator 25 limits the thickness of a layer of the developer carried on the peripheral surface of the developer sleeve 24a, so that the layer is leveled off to become a layer having a uniform layer thickness. The gap between the developer regulator 25 and the developer sleeve 24a may be adjusted, to adjust the amount of the developer to be carried on the developer roller 24 and to be transported to the development region R4.

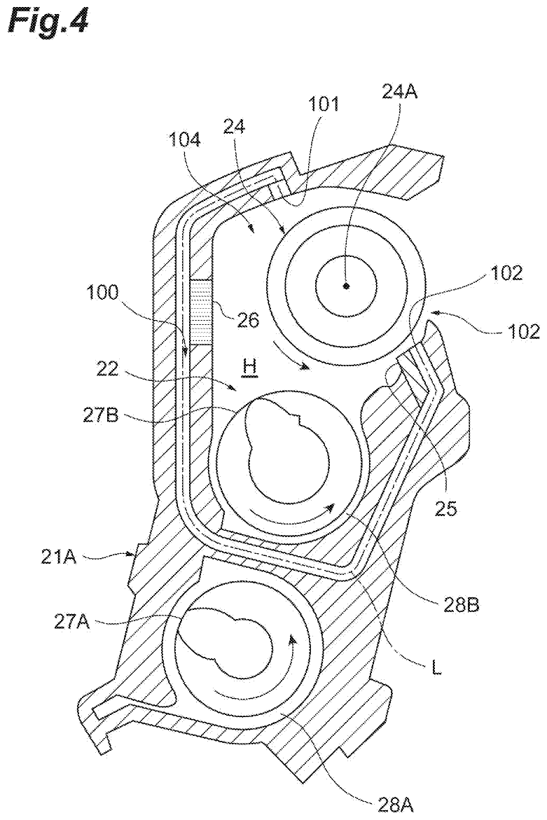

As illustrated in FIGS. 2 and 4, the air passage 100 is a flow passage which extends outside the development chamber H and through which air flows. In some examples, the air passage 100 may be formed of a hole (air passage) formed within the housing 21A. In other examples, the air passage 100 may be formed of a member (e.g., an external member) which is attached to the housing 21A such as a duct extending outside the housing 21A. In yet other examples, the air passage 100 may be formed of both a hole (air passage) formed within the housing 21A and a member such as a duct which is attached to the housing 21A. The air passage 100 has an inlet 101 to receive and to draw in an airflow, and an outlet 102 to discharge the airflow. The inlet 101 opens in the development chamber H, and the outlet 102 opens in a region between the developer regulator 25 and the development region R4. Namely, the outlet 102 opens in the region adjacent the developer roller 24 that extends from the developer regulator 25 to the development region R4, in the rotational direction of the developer roller 24.

When the developer sleeve 24a of the developer roller 24 rotates, air in the gap between the developer roller 24 and the image carrier 40, namely, in the development region R4, is pushed forward in the rotational direction of the developer roller 24 by the developer bristles formed by the developer carried on the surface of the developer roller 24. Accordingly, air is taken into the housing 21A on a downstream side of the development region R4 in the rotational direction of the developer roller 24. Consequently, a positive pressure region 104 in which is formed in the development chamber H of the housing 21A. The air pressure in the positive pressure region 104 is higher than the atmospheric pressure according to examples, or at least higher than another region in the development chamber H, such as a negative pressure region 105 which will be described further below. The opening in the housing 21A where the developer roller 24 faces the image carrier 40, extends from an upstream edge of the housing to a downstream edge of the housing in the rotational direction of the developer roller. The positive pressure region 104 is located between the developer roller 24 and the housing 21A and may extend, for example, from the downstream edge of the opening of the housing 21A, to the developer regulator 25, in the rotational direction of the developer roller 24. The developer regulator 25 limits air which enters a gap between the developer roller 24 and the developer regulator 25 on the upstream side of the development region R4 in the rotational direction of the developer roller 24. Consequently, the region adjacent the developer roller 24 that extends from the developer regulator 25 to the development region R4 in the rotational direction of the developer roller 24 forms a negative pressure region 105 where an air pressure is lower than the atmospheric pressure (or at least lower relative to the positive pressure region 104).

Then, the inlet 101 is located at the positive pressure region 104, and the outlet 102 is located at the negative pressure region 105. Accordingly, a pressure difference occurs between the inlet 101 and the outlet 102, and thus air in the positive pressure region 104 is drawn into the air passage 100 from the inlet 101, and the air drawn into the air passage 100 is discharged from the outlet 102 to the negative pressure region 105. Accordingly, an airflow occurs in the air passage 100 to flow from the inlet 101 toward the outlet 102.

The inlet 101 is, for example, located on an upstream side of the developer regulator 25 in the rotational direction of the developer roller 24. The inlet 101 is, for example, located on an upstream side, in the rotational direction of the developer roller 24, of supply region of the developer roller that is located at a position where the developer roller 24 faces the stir portion 22 (the second stir and transport member 27B). The inlet 101 is, for example, located on an upstream side of the filter 26, in the rotational direction of the developer roller 24. The plurality of magnetic poles of the developer roller 24 include a pickoff pole (or release pole) where the developer carried on the developer roller 24 is detached from the developer roller 24. The inlet 101 is, for example, located on an upstream side, in the rotational direction of the developer roller 24, of a position corresponding to the pickoff pole (e.g, on an upstream side of the pickoff pole). The outlet 102 is, for example, located within the developer regulator 25, to discharge the air flow between the developer regulator 25 and the housing 21A, or according to examples, the outlet 102 is located within the housing 21A.

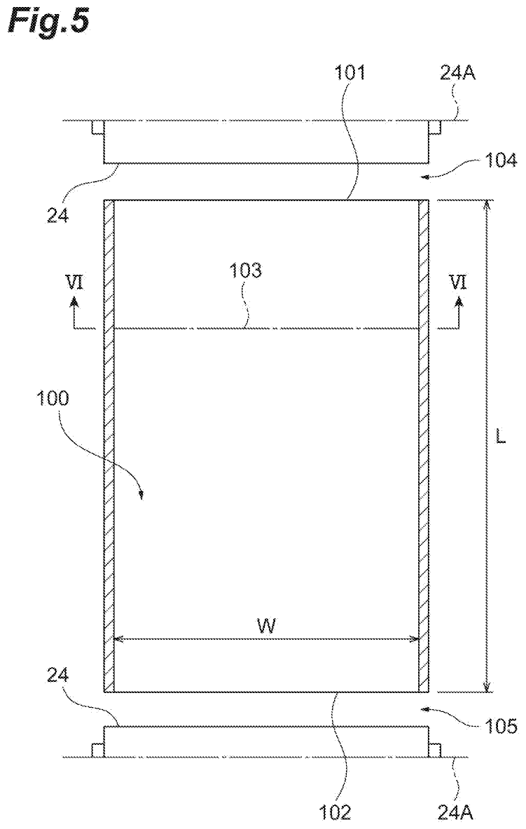

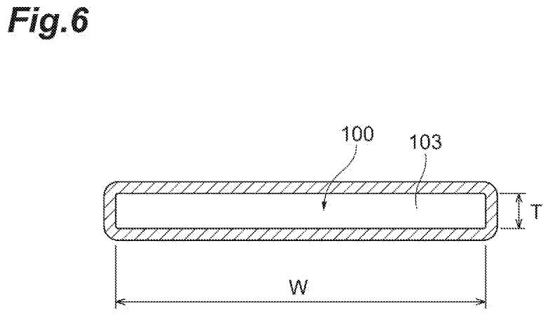

As illustrated in FIGS. 5 and 6, the air passage 100 is a flow passage having a cross section (FIG. 6) that is substantially wide and flattened in the direction parallel to the rotational axis 24A of the developer roller 24. The air passage 100 has a width W in a width direction parallel to the rotational axis 24A of the developer roller 24 (e.g., an axial direction or a longitudinal direction of the developer roller 24), a length L corresponding to a distance to be travelled by the airflow from the inlet 101 to the outlet 102, and a thickness (or depth, or height) T in a thickness direction orthogonal to the width W and the length L. The length L, which corresponds to the distance to be travelled by the airflow from the inlet 101 to the outlet 102, may refer to a length of the air passage 100 from the inlet 101 to the outlet 102 if the air passage 100 deformed to extend linearly from the inlet 101 to the outlet 102. In addition, a direction in which the airflow travels from the inlet 101 to the outlet 102 refers to a lengthwise direction, e.g., a direction along the length L of the air passage 100.

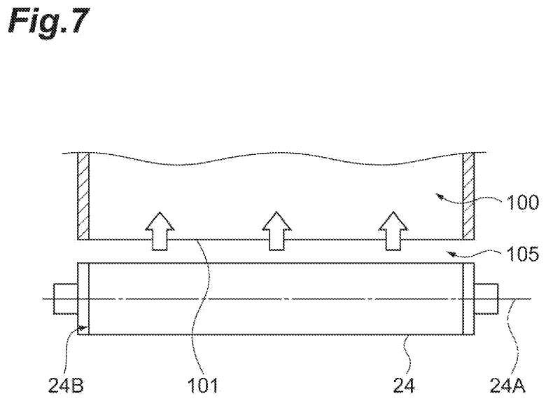

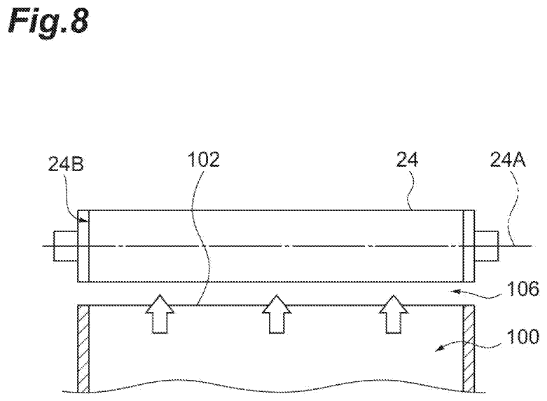

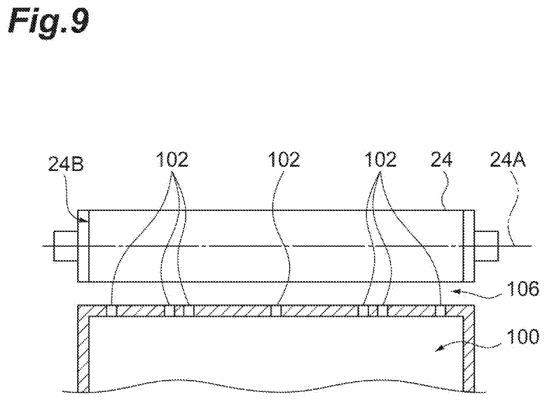

The inlet will be described with reference to FIGS. 5 and 7, with further reference to FIGS. 8 and 9. As illustrated in FIGS. 5 and 7, the inlet 101 extends parallel to the rotational axis 24A of the developer roller 24. For example, the width W of the inlet 101 may be substantially the same as the length of a developer carrying region 24B of the developer roller 24, or may be equal to or less than the length of the developer carrying region 24B of the developer roller 24. The developer carrying region 24B of the developer roller 24 is a region that is accommodated in the housing 21A and is capable of carrying the developer. The length of the developer carrying region 24B is a length in the direction parallel to the rotational axis 24A. As illustrated in FIGS. 5 and 8, the outlet 102 extends parallel to the rotational axis 24A of the developer roller 24. For example, the width W of the outlet 102 may be substantially the same as the length of the developer carrying region 24B of the developer roller 24, or in some examples, may be equal to or less than the length of the developer carrying region 24B of the developer roller 24. The outlet 102 may be formed of one outlet as illustrated in FIG. 8, or according to some examples, may be formed of a plurality of outlets as illustrated in FIG. 9. The plurality of outlets 102 may be spaced apart to face the developer roller (e.g., the outlets 102 may be located at arbitrary positions facing the developer roller 24).

As illustrated in FIGS. 5 and 6, the air passage 100 has a cross section 103 that is orthogonal to the direction of the airflow from the inlet 101 to the outlet 102. The width W is larger than the thickness T in the cross section 103 taken at a narrowest position where the air passage 100 is the narrowest other than at the inlet 101 and at the outlet 102. Namely, the air passage 100 is substantially flat in the width direction. The narrowest position is a position where the cross-sectional area of the cross section 103 is the smallest except for the inlet 101 and the outlet 102. In some examples, the width W may be four times or greater than the thickness T. The width W at the narrowest position may be substantially the same as the length of the developer carrying region 24B of the developer roller 24, or may be equal to or less than the developer carrying region 24B of the developer roller 24.

The air passage 100 may have a cross section from the inlet 101 to the outlet 102. The cross section may be taken along a plane that is orthogonal to the rotational axis 24A of the developer roller 24, and that intersects the entire length L of the air passage 100, from the inlet 101 to the outlet 102, such that the plane intersects an entire travel distance of the airflow through the air passage. Accordingly, the air passage 100 may entirely extend from the inlet 101 to the outlet 102 along at least one plane.

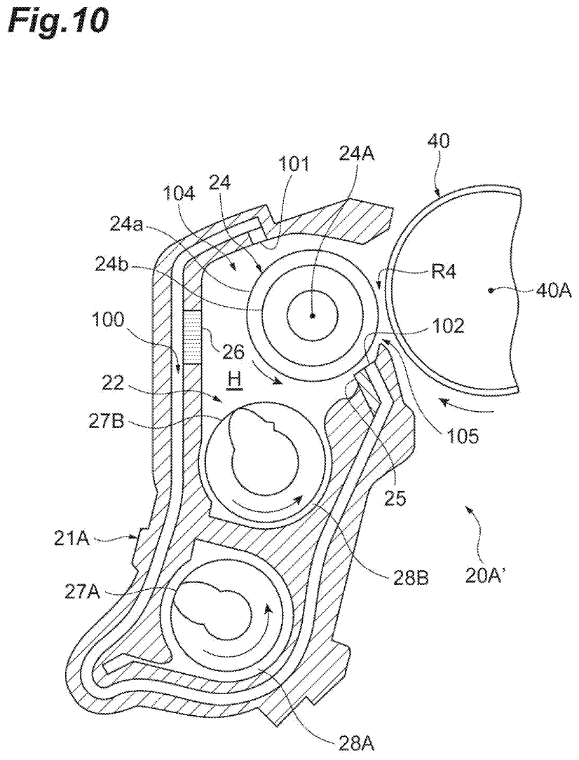

With reference to FIGS. 2 and 3, the air passage 100 may extend to surround at least part of the stir portion 22. For example, the air passage 100 may be located so as to surround part of the stir portion 22, namely, the second stir and transport member 27B and the second stir and transport path 28B. In addition, as in a developing device 20A′ illustrated in FIG. 10, the air passage 100 may extend so as to surround both the first stir and transport path 28A and the second stir and transport path 28B, or the entirety of the stir portion 22.

In the case illustrated in FIGS. 2 and 3, the air passage 100 may be located between the first stir and transport path 28A and the second stir and transport path 28B. Here, the first stir and transport path 28A and the second stir and transport path 28B are partitioned off from each other with the wall which is part of the housing 21A. The first supply port 29A and the second supply port 29B are formed at both ends of the first stir and transport path 28A and the second stir and transport path 28B. The air passage 100 is formed in the wall that partitions the first stir and transport path 28A off from the second stir and transport path 28B, in order to widen the width W of the cross-section of the air passage 100 taken between the first stir and transport path 28A and the second stir and transport path 28B. In the case illustrated in FIG. 10, the air passage 100 may be located adjacent an outer surface of the housing 21A.

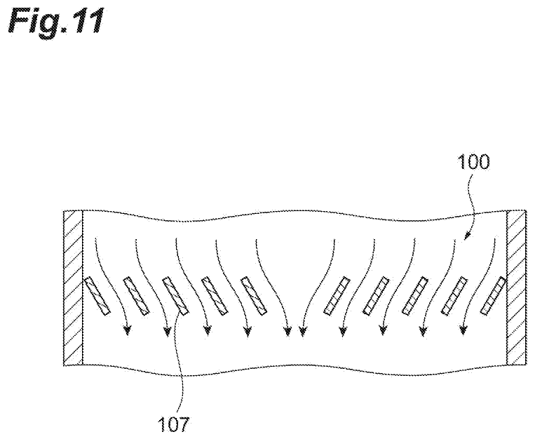

With reference to FIG. 11, a guide portion 107 may be located in the air passage 100 to guide an airflow in the air passage 100. The guide portion 107 is formed into, for example, a planar shape, and divides part of the air passage 100 into a plurality of regions. The toner may have a tendency to splash or scatter from both longitudinal ends (in the direction of the rotational axis 24A) of the developer roller 24 at the opening of the housing 21A. Accordingly, for example, the guide portion may be positioned so as to direct the airflow toward a center in the width direction of the air passage 100, in order to reduce the amount of splashing or scattering of the toner from the opening of the housing 21A.

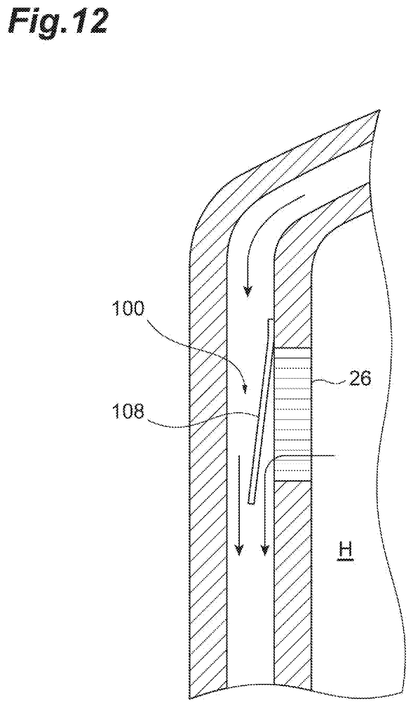

With reference to FIG. 12, the development chamber H may communicate with the air passage 100 via the filter 26, such that the air passage 100 has two inlets, including the inlet 101 which is a first inlet and the filter 26 which is a second inlet. A guide portion 108 may be provided within the air passage adjacent the filter 26 (e.g., on a side of the filter 26 which faces the air passage 100) such that air output from the filter 26 is guided in the direction of the airflow (e.g., toward the outlet 102) of the air passage 100. The guide portion 108 is formed into, for example, a planar shape or a film shape. Then, the guide portion 108 may be attached to a wall of the air passage adjacent the filter 26 at an upstream side of the filter 26 in the airflow direction of the air passage 100 so as to partially cover the filter 26, and may extend away from the wall and the filter 26 toward a downstream side in the airflow direction of the air passage 100. Consequently, after air output from the filter 26 to the air passage 100 is guided in the airflow direction of the air passage 100 by the guide portion 108, the air merges with the airflow in the air passage 100. Accordingly, it is possible to increase a flow of the airflow in the air passage 100.

As described above, in the imaging apparatus 1 including the developing device 20A illustrated in FIG. 2, as the developer roller 24 rotates, a pressure difference occurs between the inlet 101 and the outlet 102 of the air passage 100, and thus the airflow flowing from the inlet 101 toward the outlet 102 occurs. Accordingly, by inhibiting an increase in the pressure of the development chamber H, it is possible to inhibit the splashing or scattering of the toner caused by an increase in the pressure of the development chamber H. Incidentally, the scattering of the toner caused by an increase in the pressure of the development chamber H is, for example, the scattering of the toner which is output from the opening of the housing 21A, or the scattering of the toner which is output along with an airflow ejected from the developer output port of the housing 21A.

In addition, the developer drawn into the air passage 100 from the inlet 101 is output to the upstream side of the development region R4 in the rotational direction of the developer roller 24 between the developer regulator 25 and the development region R4, such that the developer is transported back and recovered into the development chamber H while being carried on the developer roller 24, so as to inhibit the scattering of the toner output from the air passage 100.

In addition, the width W is larger than the thickness T in the cross section 103 of the air passage 100 at the narrowest position, to secure a sufficient cross-sectional area of the air passage 100. Accordingly, a pressure loss of the airflow flowing through the air passage 100 decreases, to improve the flow of the airflow through the air passage 100.

In addition, the air passage 100 may extend between the first stir and transport path 28A and the second stir and transport path 28B, to further shorten the length L of the air passage 100 as compared to a case where the air passage 100 is located so as to surround the entirety of the stir portion 22. Accordingly, a pressure loss of the airflow flowing through the air passage 100 decreases, in order to improve the flow of the airflow through the air passage 100. Moreover, some of the developer may fall out of the airflow and accumulates in the air passage 100 such that the air passage 100 becomes narrow. Accordingly, a shorter length L of the air passage 100 reduces the amount of the developer that may accumulate in the air passage 100, to inhibit the air passage 100 from becoming narrow.

In addition, some of air in the development chamber H may be drawn into the air passage 100 from the filter 26, to further inhibit an increase in the pressure of the development chamber H.

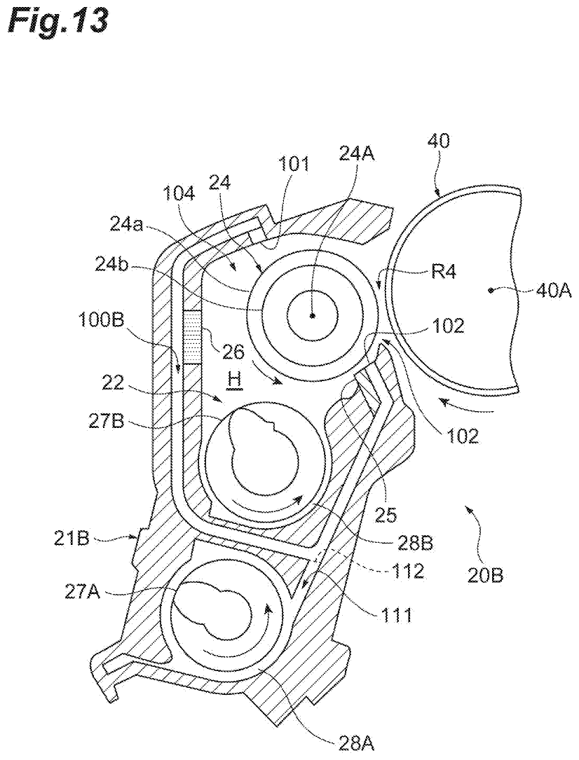

FIG. 13 is a schematic cross-sectional view of another example developing device. The example developing device 20B may be installed in the imaging apparatus 1 illustrated in FIG. 1. The developing device 20B illustrated in FIG. 13 is similar to the developing device 20A illustrated in FIG. 2, and includes an image carrier 40 that is rotatable, a housing 21B, a stir portion 22; a developer roller 24 that is rotatable, a developer regulator 25, an air passage 100B; and a branch air passage 111.

The air passage 100B and the branch air passage 111 are formed in the housing 21B which may include other configurations similar to the housing 21A of the developing device 20A illustrated in FIG. 2. The air passage 100B includes an output port 112, and other configurations similar to the air passage 100 of the developing device 20A illustrated in FIG. 2.

The output port 112 is a hole formed in the air passage 100B, between the inlet 101 and the outlet 102, in a lower portion of the air passage 100B.

The branch air passage 111 is a flow passage through which air flows. According to some examples, the branch air passage 111 may be formed of a hole (air passage) formed within the housing 21B. In other examples, the branch air passage 111 may be formed of a member (e.g., an external member) which is attached to the housing 21B such as a duct extending outside the housing 21B. In yet other examples, the branch air passage 111 may be formed of both a hole (air passage) formed in the housing 21B and a member such as a duct which is attached to the housing 21B. One end portion (or first end) of the branch air passage 111 is connected to the output port 112 of the air passage 100B. Namely, the branch air passage 111 communicates with the air passage 100B via the output port 112. The branch air passage 111 extends downward from the output port 112. The other end portion (or second end) of the branch air passage 111 is connected to the stir portion 22. The second end portion of the branch air passage 111 may be connected to a transport path of the developer in the stir portion 22, including any one of the first stir and transport path 28A, the second stir and transport path 28B, the first supply port 29A, and the second supply port 29B. As an example, the second end portion of the branch air passage 111 may be connected to the first stir and transport path 28A.

The cross-sectional area of the air passage 100B is enlarged at the output port 112 (e.g., at a position of the air passage 100B where the output port 112 of the air passage 100B is formed), to decrease the flow speed of the airflow flowing through the air passage 100B at the position of the output port 112. Accordingly, the developer scattered in the airflow is caused to fall out of the airflow, to intensively fall downwardly to the output port 112, in order to reduce an accumulation of the developer in the air passage 100B.

The branch air passage 111 extends downwardly from the output port 112, to guide the developer which has fallen down to the output port 112 along the branch air passage 111. The branch air passage 111 is connected to the stir portion 22, to supply the developer which has fallen down to the output port 112, to the stir portion 22. Accordingly, it is possible to inhibit a deficiency of the developer in the stir portion 22, and to inhibit the occurrence of an image defect.

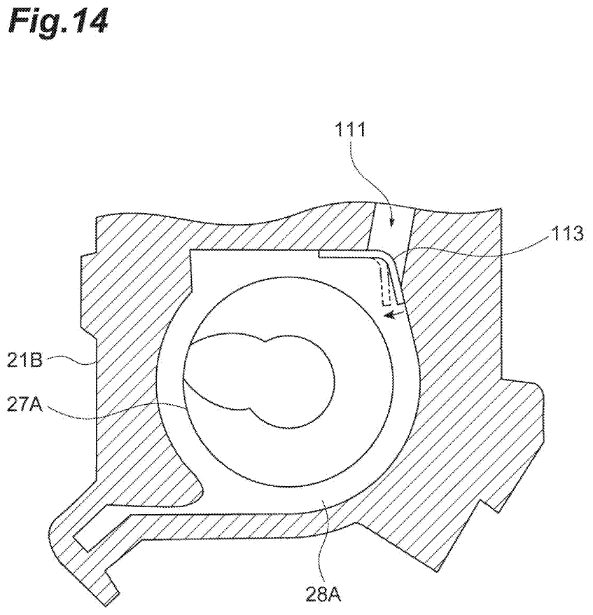

As illustrated in FIG. 14, a check valve 113 may be located at the second end portion of the branch air passage 111 which is connected to the stir portion 22. The check valve 113 allows air and the developer to move from the branch air passage 111 into the stir portion 22, and inhibits the developer from flowing backward from the stir portion 22 to the branch air passage 111. The check valve 113 may be formed of, for example, a film-like member that is elastically deformable, to block the branch air passage 111 from the stir portion 22. When a threshold amount (e.g., a predetermined amount) of the developer accumulates on the check valve 113, the check valve 113 opens the branch air passage 111. The check valve 113 may be bent by, for example, a load from the accumulated developer, in order to open the branch air passage 111. The threshold load that opens the branch air passage 111 by the check valve 113 can be suitably set according to, for example, the thickness, rigidity, and material of the check valve 113. Accordingly, the check valve 113 maintains the branch air passage 111 in a closed state until the predetermined amount of the developer accumulates on the check valve 113, to inhibit the developer from flowing backward from the stir portion 22 to the branch air passage 111. When the predetermined amount of the developer accumulates on the check valve 113, since the check valve 113 opens the branch air passage 111, the developer which has accumulated on the check valve 113 can be supplied to the stir portion 22.

Accordingly to examples, the branch air passage 111 and the output port 112 illustrated in FIG. 13 and the check valve 113 illustrated in FIG. 14 can be applied to the developing device 20A illustrated in FIG. 10. For example, in the developing device 20B illustrated in FIG. 13, as in the developing device 20A′ illustrated in FIG. 10, the air passage 100B may be located so as to surround the entirety of the stir portion 22.

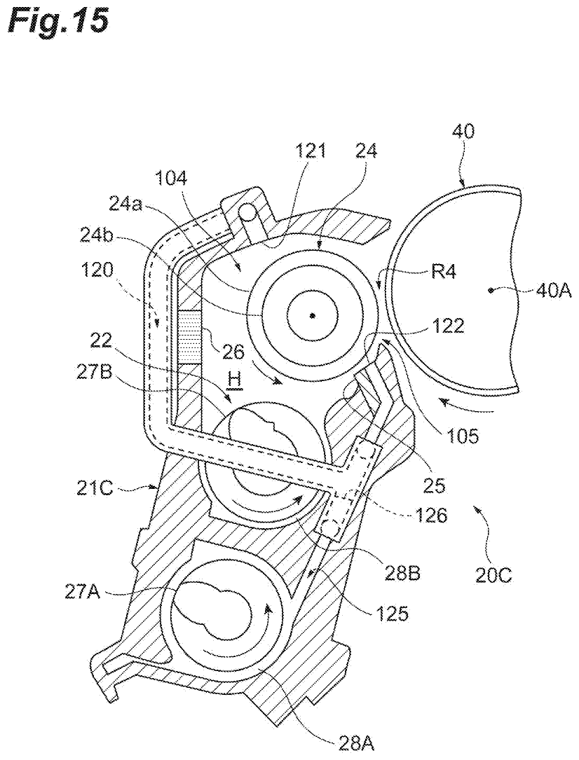

FIG. 15 is a schematic cross-sectional view of another example developing device. The example developing device 20C may be installed in the imaging apparatus 1 illustrated in FIG. 1. The developing device 20C illustrated in FIG. 15 is similar to the developing device 20B illustrated in FIG. 13, and includes an image carrier 40 that is rotatable; a housing 21C; a stir portion 22; a developer roller 24 that is rotatable; a developer regulator 25; an air passage 120; and a branch air passage 125.

The air passage 120 and the branch air passage 125 are formed in the housing 21C which may include other configurations similar to the housing 21B of the developing device 20B illustrated in FIG. 13. The air passage 120 has a different shape between the inlet and the outlet, in comparison to the air passage 100B of the developing device 20B illustrated in FIG. 13.

The air passage 120 is a flow passage which extends outside the development chamber H and through which air flows. In some examples, the air passage 120 may be formed of a hole (air passage) formed within the housing 21C. According to other examples, the air passage 120 may be formed of a member (e.g., an external member) which is attached to the housing 21C such as a duct which extends outside the housing 21C. According to yet other examples, the air passage 120 may be formed of both a hole (air passage) formed within the housing 21C and a member such as a duct which is attached to the housing 21C. The air passage 120 has an inlet 121 to receive and to draw in an airflow, and an outlet 122 to discharge the airflow. The inlet 121 and the outlet 122 are similar to the inlet 101 and the outlet 102 of the developing device 20A illustrated in FIG. 2. The inlet 121 and the outlet 122 have similar shapes and are located at similar positions as those of the inlet 101 and the outlet 102 of the developing device 20A illustrated in FIG. 2.

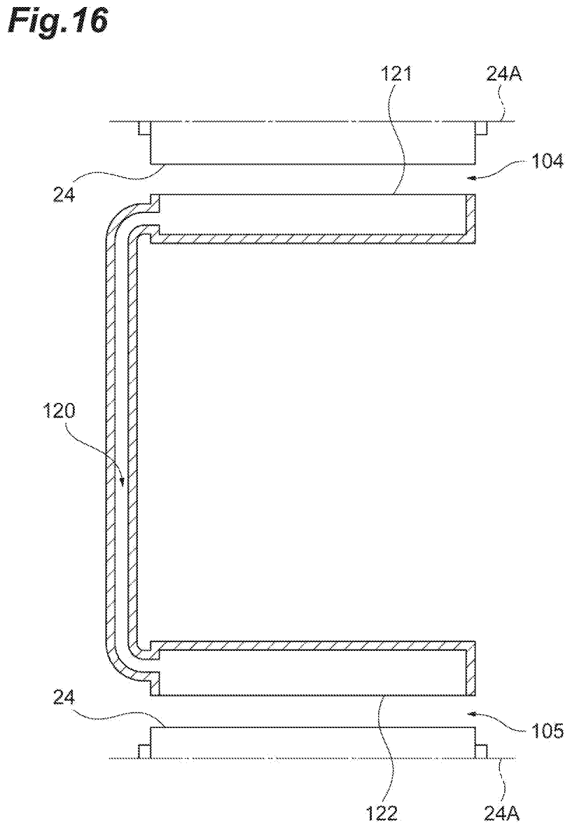

As illustrated in FIGS. 15 and 16, the air passage 120 includes a section that is formed into a pipe shape between the inlet 121 and the outlet 122 of the air passage 120. Namely, the air passage 120 has a shape where the inlet 121 which is wide is connected, via the section in the air passage 120 having a pipe shape, to the outlet 122 which is wide. The air passage 120 is positioned so as to extend around an outside the stir portion 22, so as to be offset from the stir portion 22 in a direction parallel to the rotational axis 24A of the developer roller 24.

As illustrated in FIG. 15, an output port 126 is formed in the air passage 120. The output port 126 is a hole formed in the air passage 120, and is formed between the inlet 121 and the outlet 122. The output port 126 is formed in a lower portion of the air passage 120.

The branch air passage 125 is a flow passage through which air flows. In some examples, the branch air passage 125 may be formed of a hole (air passage) formed in the housing 21C. According to other examples, the branch air passage 125 may be formed of a member (e.g., an external member) which is attached to the housing 21C such as a duct that extends outside the housing 21C. In yet other examples, the branch air passage 125 may be formed of both a hole (air passage) formed in the housing 21C and a member such as a duct which is attached to the housing 21C. One end portion (a first end) of the branch air passage 125 is connected to the output port 126 of the air passage 120. Namely, the branch air passage 125 communicates with the air passage 120 via the output port 126. The branch air passage 125 extends downward from the output port 126. The other end portion (a second end) of the branch air passage 125 is connected to the stir portion 22. The second end portion of the branch air passage 125 may be connected to a transport path of the developer in the stir portion 22, including any one of the first stir and transport path 28A, the second stir and transport path 28B, the first supply port 29A, and the second supply port 29B. The second end portion of the branch air passage 125 is connected to, for example, the first stir and transport path 28A.

The cross-sectional area of the air passage 120 is enlarged at a position of the air passage 120 adjacent the output port 126 (e.g., a position where the output port 126 of the air passage 120 is formed), to decrease the flow speed of the airflow flowing through the air passage 120 at the position of the output port 126, which causes the developer to fall out of the airflow, so that the developer contained in the airflow may intensively fall down to the output port 126, in order to to reduce an accumulation of developer in the air passage 120.

In addition, the branch air passage 125 extends downward from the output port 126, to guide the developer which has fallen down to the output port 126 along the branch air passage 125. The branch air passage 125 is connected to the stir portion 22, to supply the developer which has fallen down to the output port 126, to the stir portion 22 so as to inhibit the deficiency of the developer in the stir portion 22, in order to inhibit the occurrence of an image defect.

According to examples, in the developing device 20C, a check valve similar to the check valve 113 illustrated in FIG. 14 may be provided at the second end portion of the branch air passage 125 which is connected to the stir portion 22. The check valve may operate in a similar manner as the check valve 113 illustrated in FIG. 14.

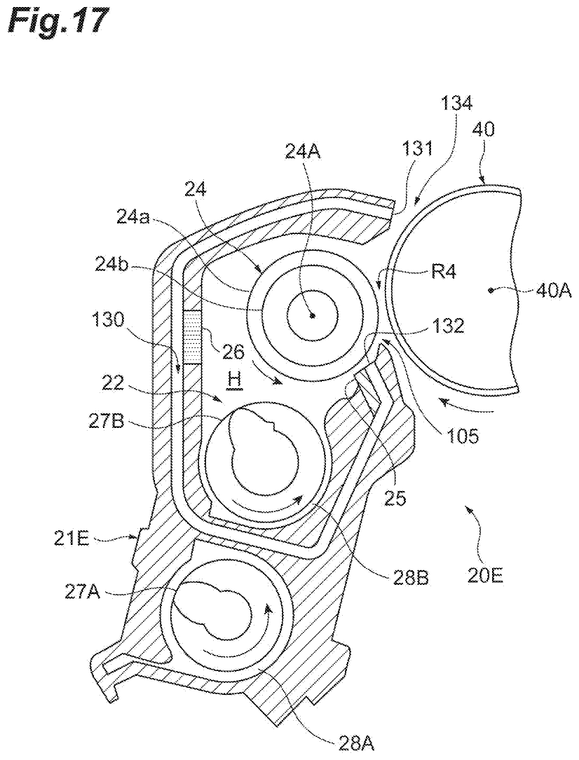

FIG. 17 is a schematic cross-sectional view of another example developing device. The example developing device 20E may be installed on the imaging apparatus 1 illustrated in FIG. 1. The developing device 20E illustrated in FIG. 17 is similar to the developing device 20A illustrated in FIG. 2, and includes an image carrier 40 that is rotatable; a housing 21E; a stir portion 22; a developer roller 24 that is rotatable; a developer regulator 25; and an air passage 130.

The air passage 130 is formed in the housing 21E which may include other configurations similar to the housing 21A of the developing device 20A illustrated in FIG. 2. The air passage 130 includes an inlet at a different position, in comparison to the air passage 100 of the developing device 20A illustrated in FIG. 2.

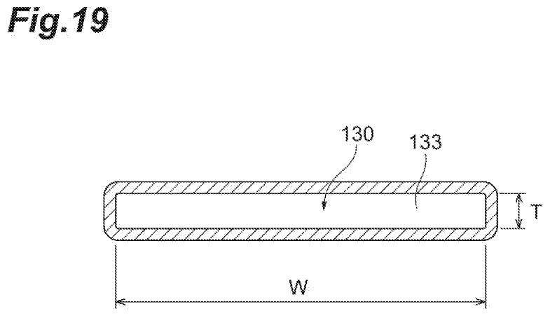

As illustrated in FIGS. 17 and 19, the air passage 130 is a flow passage which extends outside the development chamber H and through which air flows. In some examples, the air passage 130 may be formed of a hole (air passage) formed in the housing 21E. According to other examples, the air passage 130 may be formed of a member (e.g., an external member) which is attached to the housing 21E such as a duct extending outside the housing 21E. According to yet other examples, the air passage 130 may be formed of both a hole (air passage) formed in the housing 21E and a member such as a duct which is attached to the housing 21E. The air passage 130 has an inlet 131 to receive and draw in an airflow, and an outlet 132 to discharge the airflow. The outlet 132 may be similar to the outlet 102 of the developing device 20A illustrated in FIG. 2. For example, the outlet 132 may have a similar shape and may be located at a similar position as those of the outlet 102 of the developing device 20A illustrated in FIG. 2. In addition, the shape of a cross section 133 of the air passage 130, taken orthogonally to an airflow direction from the inlet 131 to the outlet 132 is the same as the shape of the cross section 103 (refer to FIG. 6) of the developing device 20A illustrated in FIG. 2. Namely, the air passage 130 is substantially wide and flattened in a width direction, and the width W is larger than the thickness T in the cross section 133 at a narrowest position where the air passage 130 is the narrowest, other than the inlet 131 and the outlet 132.

A gap 134 is formed between the housing 21E and the image carrier 40 on the downstream side of the development region R4 in the rotational direction of the developer roller 24. The inlet 131 of the air passage 130 is located adjacent to the gap 134. The inlet 131 may be located at a region where the housing 21E faces the image carrier 40. In addition, the inlet 131 may be located to communicate at least in part with an outside of the developing device 20E, for example, on a side which is opposite to the development region R4 with respect to the region where the housing 21E faces the image carrier 40.

The gap 134 opens to an outside the developing device 20E, the gap 134 forms an atmospheric pressure region having a pressure that substantially corresponds to the atmospheric pressure. Consequently, a pressure difference occurs between the inlet 131 located in the gap 134 which is an atmospheric pressure region and the outlet 132 located in the negative pressure region 105, and thus air in the gap 134 is drawn into the air passage 130 from the inlet 131, and the air drawn into the air passage 130 is discharged from the outlet 132 to the negative pressure region 105. As a result of the pressure difference, an airflow occurs in the air passage 130 to flow from the inlet 131 toward the outlet 132.

As the developer sleeve 24a of the developer roller 24 rotates, air in a region surrounded by the developer roller 24, the image carrier 40, and the housing 21E is delivered to the gap 134 by the bristles of the developer carried on the surface of the developer roller 24. Accordingly, the air delivered to the gap 134 may contain toner, and the toner contained in the air may tend to splash or scatter outside the developing device 20E from the gap 134.

Accordingly, the inlet 131 of the air passage 130 is located adjacent to the gap 134, to draw the air and the toner delivered to the gap 134 into the air passage 130, in order to inhibit the air and the toner from splashing or scattering outside the developing device 20E from the gap 134.

The developing device 20E may include a guide portion similar to the guide portion 107 illustrated in FIG. 11, adjacent the inlet 131 and/or the outlet 132. The guide portion may operate in a similar manner as the guide portion 107 illustrated in FIG. 11.

In some examples, a guide portion similar to the guide portion 108 illustrated in FIG. 12 may be provided on or adjacent a side of the filter 26 which faces the air passage 130. The guide portion operates in a similar manner as the guide portion 108 illustrated in FIG. 12.

In some examples, the air passage 130 may be located so as to surround the entirety of the stir portion 22 similarly to the developing device 20A′ illustrated in FIG. 10.

As described above, as the developer sleeve 24a of the developer roller 24 rotates, air is taken into the development chamber H by the bristles of the developer carried on the surface of the developer roller 24, which increases an air pressure in the development chamber H (internal pressure of the housing 21E). The developing device 20E outputs an aged developer from a developer output port formed in the housing 21E. However, if the air pressure in the development chamber H becomes too high, since the air in the development chamber H is ejected from the developer output port, an excess of the developer may be ejected, along with a flow of the air, from the developer output port.

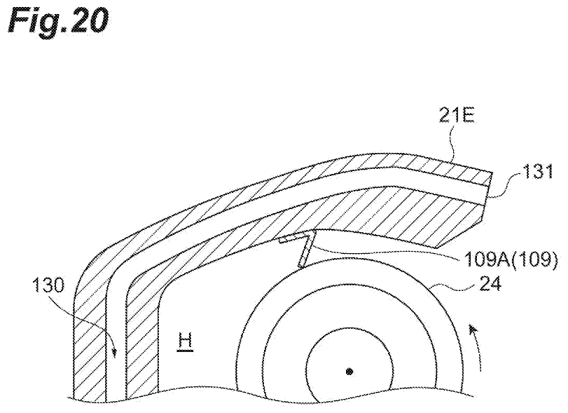

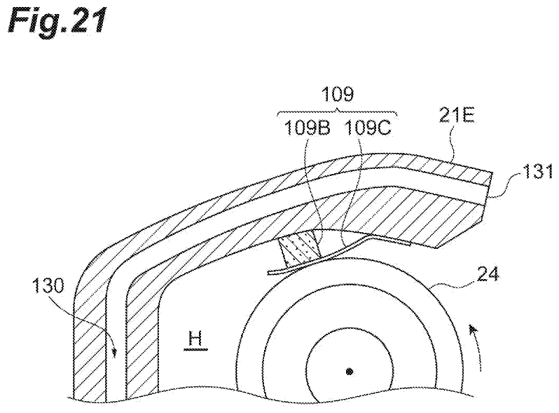

With reference to FIGS. 20 and 21, a pressure increase inhibition portion 109 may be provided adjacent to an opening of the housing 21E so as to be positioned on a downstream side of the development region R4 in the rotational direction of the developer roller 24, and so as to come into contact with the bristles of the developer carried on the surface of the developer roller 24. When the pressure increase inhibition portion 109 comes into contact with the bristles of the developer, the pressure increase inhibition portion 109 compresses the bristles of the developer to reduce the amount of air which is taken into the development chamber H by the bristles of the developer. The pressure increase inhibition portion 109 illustrated in FIG. 20 includes an elastic sheet member 109A such as a PET sheet which is elastically deformable. The elastic sheet member 109A may be attached to the housing 21E, and the bristles of the developer may be compressed by an elastic force of the elastic sheet member 109A. The pressure increase inhibition portion 109 illustrated in FIG. 21 may include a film-like member 109B such as an urethane film which has suitable shape followability, and an elastic flexible member 109C such as sponge. The film-like member 109B and the elastic flexible member 109C are attached to the housing 21E such that the film-like member 109B is located between the elastic flexible member 109C and the developer roller 24. The bristles of the developer may be compressed by an elastic force of the elastic flexible member 109C.

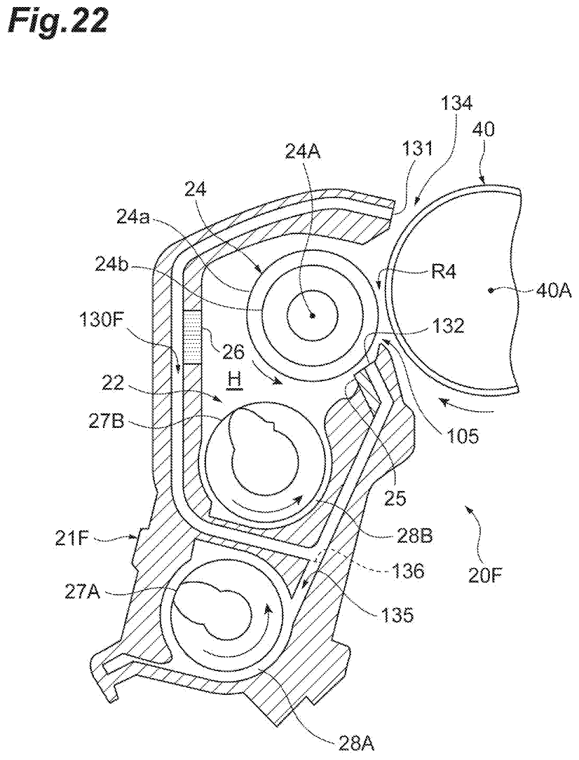

FIG. 22 is a schematic cross-sectional view of another example developing device. The example developing device 20F may be installed in the imaging apparatus 1 illustrated in FIG. 1. The developing device 20F illustrated in FIG. 22 is similar to the developing device 20E illustrated in FIG. 17, and includes an image carrier 40 that is rotatable; a housing 21F; a stir portion 22; a developer roller 24 that is rotatable; a developer regulator 25; an air passage 130F; and a branch air passage 135.

The air passage 130F and the branch air passage 135 are formed in the housing 21F which may include similar features as the housing 21E of the developing device 20E illustrated in FIG. 17. The air passage 130F is similar to the air passage 130 of the developing device 20E illustrated in FIG. 17, and further includes an output port 136.

The output port 136 is a hole formed in the air passage 130F, between the inlet 131 and the outlet 132, in a lower portion of the air passage 130F.

The branch air passage 135 is a flow passage through which air flows. According to some examples, the branch air passage 135 may be formed of a hole (air passage) formed in the housing 21F. In other examples, the branch air passage 135 may be formed of a member (e.g., an external member) which is attached to the housing 21F such as a duct extending outside the housing 21F. In yet other examples, the branch air passage 135 may be formed of both a hole (air passage) formed in the housing 21F and a member such as a duct which is attached to the housing 21F. One end portion (a first end) of the branch air passage 135 is connected to the output port 136 of the air passage 130F. Namely, the branch air passage 135 communicates with the air passage 130F via the output port 136. The branch air passage 135 extends downward from the output port 136. The other end portion (a second end) of the branch air passage 135 is connected to the stir portion 22. The second end portion of the branch air passage 135 may be connected to a transport path of the developer in the stir portion 22, including any one of the first stir and transport path 28A, the second stir and transport path 28B, the first supply port 29A, and the second supply port 29B. The second end portion of the branch air passage 135 is connected to, for example, the first stir and transport path 28A.

The cross-sectional area of the air passage 130F is enlarged at a position where the output port 136 of the air passage 130F is formed, to decrease the flow speed of an airflow flowing through the air passage 130F at the position of the output port 136, such that the developer tends to fall out of the airflow, to cause the developer contained in the airflow to intensively fall down to the output port 136, so as to reduce an accumulation of the developer in the air passage 130F.

The branch air passage 135 extends downward from the output port 136, to guide the developer which has fallen down to the output port 136 along the branch air passage 135. The branch air passage 135 is connected to the stir portion 22, to supply the developer which has fallen down to the output port 136, to the stir portion 22, so as to inhibit the deficiency of the developer in the stir portion 22, and to inhibit the occurrence of an image defect.

In some examples, in the developing device 20F, a check valve similar to the check valve 113 illustrated in FIG. 14 may be provided at the second end portion of the branch air passage 135 which is connected to the stir portion 22. The check valve may operate similarly to the check valve 113 illustrated in FIG. 14.

In some examples, the air passage 130F may be located so as to surround the entirety of the stir portion 22, similarly to the developing device 20A′ illustrated in FIG. 10.

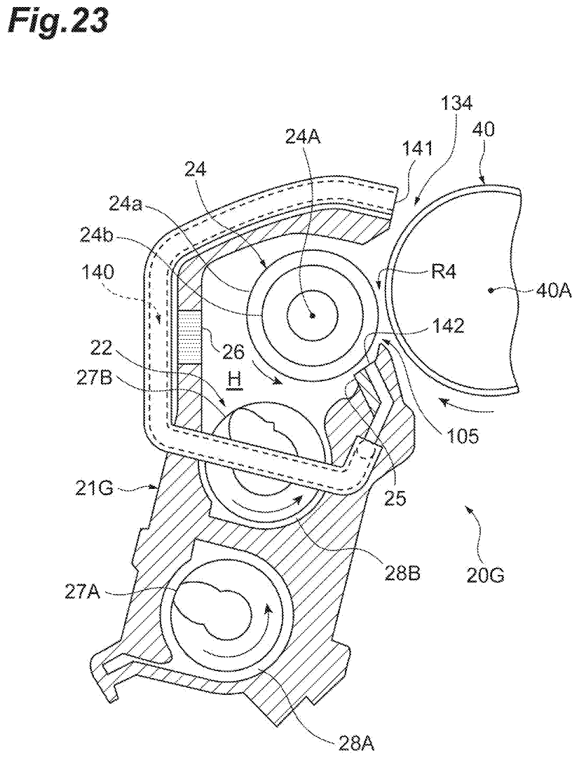

FIG. 23 is a schematic cross-sectional view of another example developing device. The example developing device 20G illustrated in FIG. 23 may be installed in the imaging apparatus 1 illustrated in FIG. 1. The developing device 20G illustrated in FIG. 23 is similar to the developing device 20E illustrated in FIG. 17, and includes an image carrier 40 that is rotatable; a housing 21G; a stir portion 22; a developer roller 24 that is rotatable; a developer regulator 25; and an air passage 140.

The air passage 140 is formed in the housing 21G which may include similar features as the housing 21E of the developing device 20E illustrated in FIG. 17. The air passage 140 has shape between an inlet and an outlet that is different from the air passage 130 of the developing device 20E illustrated in FIG. 17.

The air passage 140 is a flow passage which extends outside the development chamber H and through which air flows. In some examples, the air passage 140 may be formed of a hole (air passage) formed within the housing 21G. In some examples, the air passage 140 may be formed of a member (e.g., an external member) which is attached to the housing 21G such as a duct extending outside the housing 21G. In some examples, the air passage 140 may be formed of both a hole (air passage) formed in the housing 21G and a member such as a duct which is attached to the housing 21G. The air passage 140 has an inlet 141 to receive and draw in an airflow, and an outlet 142 to discharge the airflow. The inlet 141 and the outlet 142 are similar to the inlet 131 and the outlet 132 of the developing device 20E illustrated in FIG. 17. For example, the inlet 141 and the outlet 142 have similar shapes and are located at similar positions to those of the inlet 131 and the outlet 132 of the developing device 20E illustrated in FIG. 17.

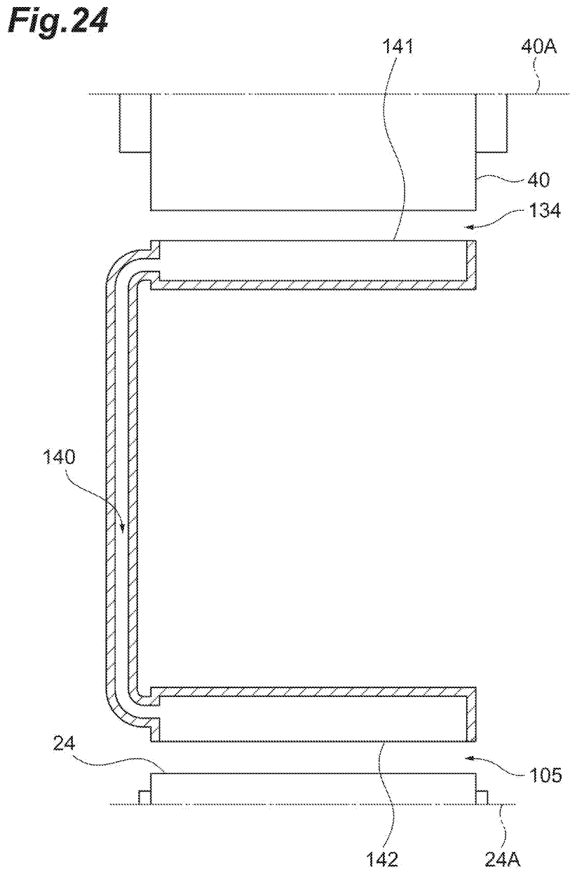

As illustrated in FIGS. 23 and 24, the air passage 140 includes a section that is formed into a pipe shape between the inlet 141 and the outlet 142 of the air passage 140. Namely, the air passage 140 has a shape where the inlet 141 which is wide is connected, via the air passage 140 including a section having a pipe shape, to the outlet 142 which is wide. The air passage 140 extends so as to go around outside the stir portion 22, to be offset from the stir portion 22 in the direction parallel to the rotational axis 24A of the developer roller 24.

In some examples, the developing device 20G may include a guide portion similar to the guide portion 107 illustrated in FIG. 11, that is located adjacent to the inlet 141 or the outlet 142. The guide portion may operate in a similar manner as the guide portion 107 illustrated in FIG. 11.

In addition, the development chamber H may communicate with the air passage 140 via a filter 26, and a guide portion similar to the guide portion 108 illustrated in FIG. 12 may be provided on a wall of the air passage 140 (e.g., a side of the filter 26 which faces the air passage 140). The guide portion may operate in in a similar manner as the guide portion 108 illustrated in FIG. 12.

In addition, a pressure increase inhibition portion similar to the pressure increase inhibition portion 109 illustrated in FIGS. 20 and 21 may be provided adjacent to an opening of the housing 21G so as to be positioned on the downstream side of the development region R4 in the rotational direction of the developer roller 24. The pressure increase inhibition portion may operate in a similar manner as the pressure increase inhibition portion 109 illustrated in FIGS. 20 and 21.

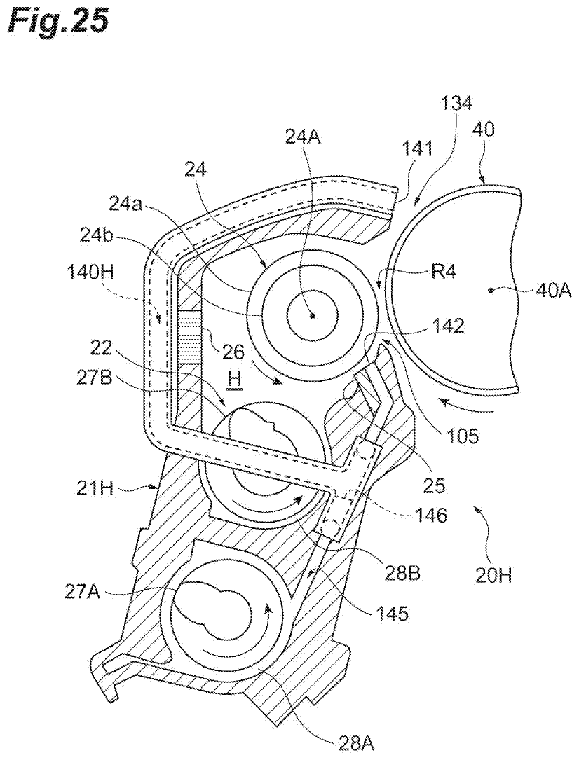

FIG. 25 is a schematic cross-sectional view of another example developing device. The example developing device 20H may be installed in the imaging apparatus 1 illustrated in FIG. 1. The developing device 20H illustrated in FIG. 25 is similar to the developing device 20G illustrated in FIG. 23, and includes an image carrier 40 that is rotatable; a housing 21H; a stir portion 22; a developer roller 24 that is rotatable; a developer regulator 25; an air passage 140H; and a branch air passage 145.

The air passage 140H and the branch air passage 145 are formed in the housing 21H which may include other configurations similar to the housing 21G of the developing device 20G illustrated in FIG. 23. The air passage includes an output port 146 and may include other configurations similar to the air passage 140 of the developing device 20G illustrated in FIG. 23.

The output port 146 is a hole formed in the air passage 140H, between the inlet 141 and the outlet 142 and in a lower portion of the air passage 140H.

The branch air passage 145 is a flow passage through which air flows. According to examples, the branch air passage 145 may be formed of a hole (air passage) formed in the housing 21H. In other examples, the branch air passage 145 may be formed of a member (e.g., an external member) which is attached to the housing 21H such as a duct extending outside the housing 21H. In yet other examples, the branch air passage 145 may be formed of both a hole (air passage) formed in the housing 21H and a member such as a duct which is attached to the housing 21H. One end portion (a first end) of the branch air passage 145 is connected to the output port 146 of the air passage 140H. Accordingly, the branch air passage 145 communicates with the air passage 140H via the output port 146. The branch air passage 145 extends downward from the output port 146. The other end portion (a second end) of the branch air passage 145 is connected to the stir portion 22. The second end portion of the branch air passage 145 is connected to a transport path of the developer in the stir portion 22, including any one of the first stir and transport path 28A, the second stir and transport path 28B, the first supply port 29A, and the second supply port 29B. The second end portion of the branch air passage 145 is connected to, for example, the first stir and transport path 28A.

The cross-sectional area of the air passage 140H is enlarged at a position of the air passage, where the output port 146 of the air passage 140H is formed, to decrease the flow speed of an airflow flowing through the air passage 140H at the position of the output port 146. Accordingly, the developer is likely to fall out of the airflow at the position of the output port, and the developer contained in the airflow may intensively fall down to the output port 146, so as to reduce the amount of the developer to accumulate in the air passage 140H.

In addition, the branch air passage 145 extends downward from the output port 146, to guide the developer which has fallen down to the output port 146 along the branch air passage 145. The branch air passage 145 is connected to the stir portion 22, the developer which has fallen down to the output port 146 can be supplied to the stir portion 22, so as to inhibit the deficiency of the developer in the stir portion 22, and to inhibit the occurrence of an image defect.

In some examples, the developing device 20H may include a check valve similar to the check valve 113 illustrated in FIG. 14 at the second end portion of the branch air passage 145 which is connected to the stir portion 22. The check valve may operate similarly to the check valve 113 illustrated in FIG. 14.

It is to be understood that not all aspects, advantages and features described herein may necessarily be achieved by, or included in, any one particular example. Indeed, having described and illustrated various examples herein, it should be apparent that other examples may be modified in arrangement and detail.

For example, the air passage may be formed of a single air hole, or may be formed of a plurality of air holes. The plurality of air holes may each have a width and a cross-sectional area, and the width W (or cross-sectional area) of the air passage at the narrowest position may correspond to a sum of widths (or sum of cross-sectional areas) of the plurality of air holes, taken where the sum of widths is the lowest or where the sum of the cross-sectional areas is the smallest. In addition, in examples in which the air passage is located between the first stir and transport path and the second stir and transport path and the air passage is formed of a plurality of air holes, part of the air holes may be located between the first supply port and the second supply port, and the remaining air holes may be located outside the first supply port and the second supply port (e.g., excluding the region between the first supply port and the second supply port).

In addition, for example, in the developing devices illustrated in FIGS. 15, 23, and 25, the air passage having a pipe shape has been described as an example; however, various shapes of air passages may be applied to the developing devices.

1. An imaging system comprising:
a housing including a development chamber;
a developer roller located in the development chamber, wherein the developer roller is rotatable about a rotational axis to transfer developer to an image carrier at a development region where the developer roller is the closest to the image carrier;
a developer regulator located adjacent the developer roller on an upstream side of the development region in a rotational direction of the developer roller, to limit a thickness of the developer carried on the developer roller; and
an air passage that extends outside the development chamber, the air passage having an inlet to draw an airflow, and an outlet located between the developer regulator and the development region,
wherein the air passage has a cross section that is orthogonal to a direction of the airflow from the inlet to the outlet, the cross section having a width in a width direction that is parallel to the rotational axis of the developer roller, and a thickness that is perpendicular to the width direction, and
wherein in the cross section taken at a narrowest position within of the air passage other than the inlet and the outlet, where the air passage is the narrowest in the width direction, the width of the cross section is greater than the thickness of the cross-section.

2. The imaging system according to claim 1,
wherein the width is at least four times greater than the thickness in the cross section of the air passage taken at the narrowest position.

3. The imaging system according to claim 1,
wherein the inlet of the air passage forms an opening in the development chamber on an upstream side of the developer regulator in the rotational direction of the developer roller.

4. The imaging system according to claim 3, comprising:
a stir portion that to stir the developer and to supply the developer to the developer roller, wherein the stir portion faces the developer roller at a supply region of the developer roller,
wherein the inlet is located on an upstream side of the supply region.

5. The imaging system according to claim 3,
wherein the developer roller includes a pickoff pole to release the developer carried on the developer roller, and
wherein the inlet of the air passage is located on an upstream side, in the rotational direction of the developer roller, of a position corresponding to the pickoff pole.

6. The imaging system according to claim 1, comprising:
a stir portion to stir the developer,
wherein the air passage extends so as to at least partially surround the stir portion.

7. The imaging system according to claim 1, comprising:
a first stir and transport path that extends parallel to the rotational axis of the developer roller, and
a second stir and transport path located between the first stir and transport path and the developer roller, and that extends parallel to the first stir and transport path,
wherein the air passage extends between the first stir and transport path and the second stir and transport path.

8. The imaging system according to claim 1,
wherein the inlet of the air passage corresponds to a first inlet of the air passage,
wherein the air passage has a second inlet positioned along the air passage between the first inlet and the outlet, and
wherein the second inlet connects the development chamber to the air passage and accommodates a filter to remove developer from air passing through the filter from the development chamber.

9. The imaging system according to claim 1, comprising:
a plurality of air holes that form the air passage,
wherein the width of the cross section at the narrowest position corresponds to a sum of widths of the plurality of air holes, taken in the width direction.

10. The imaging system according to claim 1,
wherein a gap is formed between the housing and the image carrier on a downstream side of the development region in the rotational direction of the developer roller, and
wherein the inlet is located adjacent to the gap between the housing and the image carrier.

11. The imaging system according to claim 1,
wherein the air passage has an output port between the inlet and the outlet.

12. The imaging system according to claim 11,
wherein the output port is formed in a lower portion of the air passage to discharge developer from the air passage.

13. The imaging system according to claim 11, comprising:
a branch air passage that extends downward from the output port.

14. The imaging system according to claim 13, comprising:
a stir portion to stir developer,
wherein the branch air passage is connected to the stir portion.

15. An imaging system comprising:
a housing including a development chamber;
a developer roller located in the development chamber, wherein the developer roller is rotatable about a rotational axis to transfer developer to an image carrier at a development region where the developer roller is the closest to the image carrier;
a developer regulator to limit a thickness of the developer carried on the developer roller, wherein the developer regulator is located adjacent to the developer roller on an upstream side of the development region in a rotational direction of the developer roller; and
an air passage that extends outside the development chamber, the air passage having an inlet to receive an airflow, and an outlet located between the developer regulator and the development region to discharge the airflow,
wherein the air passage has a cross section taken along a plane that is orthogonal to the rotational axis of the developer roller, and wherein the cross section intersects the air passage along an entire length of the air passage, from the inlet to the outlet.
